(19) United States
(12) Patent Application Publication
(10) Pub. No.: US 2017/0131973 A1
(43) Pub. Date: May 11, 2017

(54) SOFTWARE SPECIFICATION DEPENDENCE RELATION VERIFICATION APPARATUS AND SOFTWARE SPECIFICATION DEPENDENCE RELATION VERIFICATION METHOD

(71) Applicant: HITACHI, LTD., Tokyo (JP)

(72) Inventors: Masatoshi Murakami, Tokyo (JP); Yuichiroh Nakagawa, Tokyo (JP); Ryota Mibe, Tokyo (JP); Naoki Furuya, Tokyo (JP)

(73) Assignee: HITACHI, LTD., Tokyo (JP)

(21) Appl. No.: 15/118,156

(22) PCT Filed: Mar. 25, 2014
(86) PCT No.: PCT/JP2014/058171

§ 371 Date: Aug. 11, 2016

(51) Int. Cl. G06F 9/44

(52) U.S. Cl. CPC G06F 8/10

(57) ABSTRACT

Mismatches between software specifications are detected by dependence relation verification. A software specification consistency verification apparatus has a specification structure analysis unit configured to obtain corresponding software specifications, and extract each specification item whose relative position in the software specifications is preliminarily set; a specification item matching unit configured to determine whether there exists a dependence relation between the specification items, using matching rules describing a dependence relation between the corresponding specification items; a dependence relation information generating unit configured to extract dependence relation information specifying the specification items determined to have a dependence relation; a dependence relation verifying unit configured to determine, on the basis of dependence relation information, whether the matching condition is satisfied and, when it is determined that the matching condition is not satisfied, output the dependence relation as mismatch information; and a verification result visualization unit configured to output the mismatch information.

### TECHNICAL FIELD

The present invention relates to a software specification dependence relation verification apparatus and a software specification dependence relation verification method.

### BACKGROUND ART

Mismatches that may occur between a plurality of software specifications in a large-scale software development are the major reason for a budget overrun due to reworking in the development process, and therefore it is necessary to detect and correct such mismatches at an early stage of the development. In order to detect mismatches between software specifications, it is effective to verify mismatches on the basis of dependence relation between the software specifications. Here, “dependence relation” is a relation that holds between corresponding specification items included in corresponding specifications such as between the basic functional specification and the detailed functional specification of certain software, and means that corresponding specification items “match” each other, for example. Here, in the present DESCRIPTION, for simplicity, “software specification” will be simply referred to hereafter as “specification”.

There is a technique as prior art for verifying a dependence relation between a plurality of specifications, which uses information indicating dependence relation between specifications of interest and to display the information graphically in a form of a diagram or a list. Making use of the technique allows for grasping a dependence relation between specifications at first sight without taking time and effort for opening a plurality of software specifications and comparing them side by side. Accordingly, it becomes possible to detect mismatches of dependence relation between specifications such as inadequacies or contradictions.

Such a technique is disclosed in Patent Literatures 1 and 2, for example. Patent Literature 1 discloses “a product management apparatus configured to manage products created in each step of a software process including a plurality of steps, the apparatus including: a product input unit configured to receive, from an input device, an input of a product created in a predetermined step of the software process for developing a predetermined system; an information extraction unit configured to search, using a processing device, a predetermined keyword from the product input from the product input unit, and extract a search-point information indicating a searched point; a traceability information creating unit configured to create, using the processing device, traceability information for managing relation between products generated in the each step in the predetermined system, from the search-point information extracted by the information extraction unit; and a traceability information storage unit configured to store the traceability information created by the traceability information creating unit in a storage device. In addition, the Patent Literature 2 discloses a “a method of verifying whether or not a requirement specification is appropriately reflected in a design specification at the time of software development, the method including: providing a requirement specification identifier to a requirement document having described therein a requirement specification for software to be developed and storing the requirement document in a document database (STEP11); providing a design specification identifier to a design document created on the basis of the requirement document, and storing the design document in the document database (STEP12); inputting a requirement document from the document database, and creating a requirement specification list on the basis of the requirement specification identifier (STEP13); inputting a design document from the document database, and creating a design specification list on the basis of the design specification identifier (STEP14); checking the correspondence of identifiers provided to each item of the requirement document and the design document, and examining redundancy or inadequacy of the requirement specification (STEP15); and, when there is redundancy or inadequacy in the verification result, outputting a warning message of redundancy-or-inadequacy of the requirement specification (STEP16)”.

### CITATION LIST

### Patent Literature

### [PTL 1]

### Japanese Patent Application Laid-Open Publication No. 2011-253345

### [PTL 2]

Japanese Patent Application Laid-Open Publication No. H08-249168

### SUMMARY OF INVENTION

### Technical Problem

However, the techniques of the Patent Literatures 1 and require dependence relation between specifications, or information equivalent thereto (traceability information generated from the search-point information based on a predetermined keyword search in the case of the Patent Literature 1, requirement specification identifier in the case of the Patent Literature 2) to be preliminarily defined inside or outside the specifications in order to verify dependence relation between specifications. In such a case, there is a problem that it takes many man-hours to define a large amount of specifications in their entirety and, even if the defining is accomplished with enormous man-hours, it is difficult to update without omission the dependence relation between specifications while following revision of the specifications. Assuming that dependence relation between specifications is updated without omission, there is a problem that a large amount of presentation turns out to be entwined in a complicated manner in the course of visualization processing of the verification result, making it difficult to actually grasp the dependence relation between specifications.

In addition, the aforementioned techniques of the Patent Literatures 1 and 2 allow mismatches of dependence relation between specifications to be detected as redundancy or inadequacy of items. For example, the Patent Literature 1 determines presence or absence of mismatch points between products on the basis of a traceability matrix as traceability information. In addition, the Patent Literature 2 checks the correspondence between identifiers provided to respective items of a requirement document and a design document, and examines redundancy or inadequacy of the requirement specification. Such an approach of detecting mismatches on the basis of redundancy or inadequacy of items has a problem that it cannot detect a contradiction, if any, between the dependence relations. There is a contradiction in data lock or the like as a contradiction in dependence relation between specifications. When, for example, there is defined an requirement item to be accessed with an exclusive lock on a particular data in the requirement specification, the definition must also require that the same data in the corresponding design item defined in the design specification by detailing the requirement item needs to be accessed with the same exclusive lock being put thereon. When, however, there occurs omission of confirming due to separate files, the lock may be erroneously defined in the design specification item not as an exclusive lock but as a shared lock. In such a case, dependence relations of data access, namely, an exclusive lock and a shared lock occur simultaneously, and it turns out that a contradiction has occurred between the requirement specification and the design specification. Such a contradiction between specifications cannot be detected by only confirming omission of dependence relation between specifications.

In view of the aforementioned problems, the present invention is directed to provide a software specification dependence relation verification apparatus and a software specification dependence relation verification method capable of confirming that there exists a dependence relation between specifications without any redundancy or inadequacy, and also detecting a contradiction of dependence relation occurring between dependence relations.

### Solution to Problem

An aspect of the present invention to solve the above and other problems is a software specification consistency verification apparatus, which is a verification apparatus for verifying consistency of specification items that are data items included in software specifications having a hierarchical structure, the software specification consistency verification apparatus including: a specification structure analysis unit configured to obtain at least a pair of software specifications corresponding to each other, and extract the respective specification items whose relative positions in the software specifications are preliminarily set in accordance with the hierarchical structure; a matching rule storage unit having stored therein matching rules describing a dependence relation, which is a correspondence relation supposed to hold between the specification items included in the software specifications corresponding to each other; a specification item matching unit configured to determine whether or not there exists a dependence relation between the respective specification items, using the matching rules; a dependence relation information generating unit configured to extract, as dependence relation information, information specifying a combination of the specification items determined by the specification item matching unit to have a dependence relation; a verification rule storage unit having stored therein verification rules defining, in a form of rules, matching conditions supposed to hold between the software specifications for a particular combination of the specification items; a dependence relation verifying unit configured to determine whether or not there exists a dependence relation which does not satisfy the matching condition defined in the verification rules stored in the verification rule storage unit for the particular combination of the specification items on the basis of the extracted dependence relation information and, when it is determined that there exists a dependence relation that does not satisfy the matching condition, output the dependence relation that does not satisfy the matching condition as mismatch information indicating a mismatch between the software specifications; and a verification result output unit configured to output, via a predetermined user interface, the mismatch information from the dependence relation verifying unit.

### Advantageous Effects of Invention

According to the present invention, there is provided a software specification dependence relation verification apparatus and a software specification dependence relation verification method capable of confirming that there exists a dependence relation between specifications without any redundancy or inadequacy, and also detecting a contradiction of dependence relation occurring between dependence relations.

### BRIEF DESCRIPTION OF DRAWINGS

FIG. 1 illustrates an exemplary software configuration of a software specification dependence relation verification apparatus according to an embodiment of the present invention.

FIG. 2 illustrates an exemplary hardware configuration of the software specification dependence relation verification apparatus according to an embodiment of the present invention.

FIG. 3 illustrates exemplary specification data relating to a function to be verified.

FIG. 4 illustrates an exemplary schema definition defining the specification data structure of FIG. 3.

FIG. 5 illustrates exemplary specification data relating to a flow of a process to be verified.

FIG. 6 illustrates an exemplary schema definition defining the specification data structure of FIG. 5.

FIG. 7 illustrates an exemplary configuration of a matching rule database 104 defining a matching rule between schema definitions of FIGS. 4 and 6.

FIG. 8 illustrates an exemplary configuration of a dependence relation information database 107.

FIG. 9A illustrates an exemplary configuration of a verification rule database 108 defining verification rules that hold between dependence relations.

FIG. 9B is a schematic diagram illustrating a dependence relation that holds between a plurality of specification items.

FIG. 10 illustrates an exemplary specification structure analysis process flow 1000.

FIG. 11 illustrates an exemplary specification item matching process flow 1100.

FIG. 12 illustrates an exemplary dependence relation information generation process flow 1200.

FIG. 13 illustrates an exemplary dependence relation verification process flow 1300.

FIG. 14 illustrates an exemplary verification result visualization process flow 1400.

FIG. 15 illustrates an exemplary verification result visualization screen.

FIG. 16 illustrates another exemplary verification result visualization screen.

### DESCRIPTION OF EMBODIMENTS

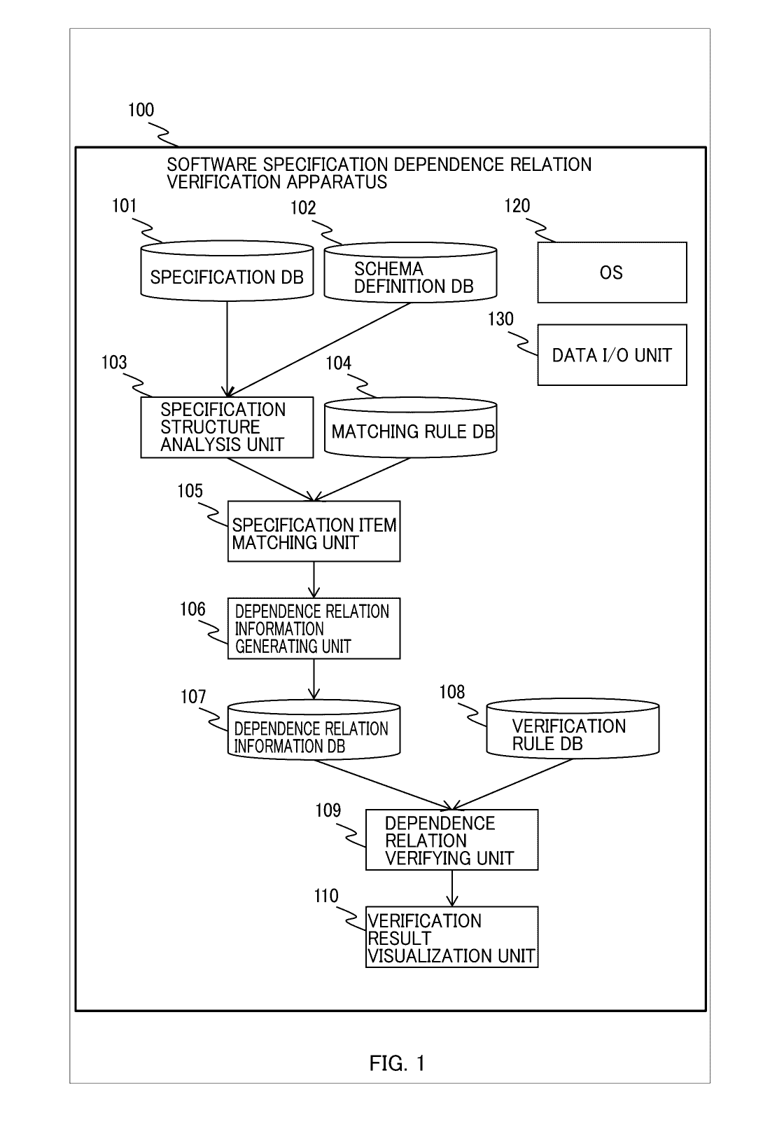

In the following, the present invention will be described in line with an embodiment thereof, referring to accompanying drawings. First, an exemplary configuration of a software specification dependence relation verification apparatus 100 according to an embodiment of the present invention will be described. FIG. 1 illustrates an exemplary software configuration of the software specification dependence relation verification apparatus 100 of the present embodiment (simply referred to as “verification apparatus”, in the following). The verification apparatus 100 is an apparatus configured to detect mismatches between software specifications at an early stage, so as to realize reduction of reworking in software development. The verification apparatus 100 includes a database (“DB”, in the following) having stored therein specification data to be verified, various data to be used in a verification process, and the like, and respective processing units configured to perform a software specification dependence relation verification process of the present embodiment using the various data stored in the DB.

As illustrated in FIG. 1, there are provided DBs such as a specification DB 101 having stored therein software specifications to be verified, a schema definition DB 102 having stored therein schema definitions defining description rules applied to software specifications to be verified, a matching rule DB 104 having stored therein matching rules, which are rules describing dependence relation establishment conditions between specification items included in the specification data, a dependence relation information DB 107 having stored therein presence or absence of dependence relations between specification items in association with specification item information, and a verification rule DB 108 having stored therein verification rules defining, in a form of rules, matching conditions supposed to hold between specifications, such as match of terms. The DBs are stored in a memory or an auxiliary storage device of the verification apparatus 100 described below, and read out and used at an appropriate timing. Specific configurations of the respective DBs will be described below.

Next, there are included, as processing units, a specification structure analysis unit 103, a specification item matching unit 105, a dependence relation information generating unit 106, a dependence relation verifying unit 109, and a verification result visualization unit 110 (verification result output unit), as also illustrated in FIG. 1. In FIG. 1, respective processing units and the like are associated with each other by arrows along the flow of data processing performed by the verification apparatus 100 of the present embodiment described below. The specification structure analysis unit 103 performs a process of referring to a specification to be analyzed stored in the specification DB 101, obtaining a schema definition corresponding to the specification to be verified from the schema definition DB 102, analyzing the specification structure, and extracting structured specification data.

The specification item matching unit 105 performs a process of extracting a matching rule, which is a rule describing dependence relation establishment conditions between specification items included in the extracted specification data from the matching rule DB 104, and extracting presence or absence of a dependence relation between specification items from the specification data extracted by the specification structure analysis unit 103.

The dependence relation information generating unit 106 performs a process of listing the presence or absence of a dependence relation between the specification items extracted by the specification item matching unit 105, and storing the list in the dependence relation information DB 107 in association with the specification items extracted from the respective specifications to be verified.

The dependence relation verifying unit 109 performs a process of extracting dependence relation information from the dependence relation information DB 107, obtaining a defined verification rule from the verification rule DB 108, verifying whether or not there exists a dependence relation violating the verification rule between the dependence relation information and, when it is determined that there exists a violation, outputting the violation as specification mismatch information.

The verification result visualization unit 110 performs a process of visualizing and outputting the specification mismatch information output from the dependence relation verifying unit 109. Here, an approach of outputting the mismatch information via audio information, for example, other than visual information may also be employed as appropriate. The processing units are configured as computer programs, stored in a memory or an auxiliary storage device of the verification apparatus 100 described below, and performed by a processor at an appropriate timing. The data processing flow performed by each processing unit will be described below, referring to an exemplary process flow.

Note that, the verification apparatus 100 is provided with an operating system (OS) 120 on which respective programs are supposed to operate, and a data input/output unit (data I/O unit) 130 that performs data input/output processing to and from respective programs. The OS 120 and the data I/O unit 130 may be selected and employed as appropriate in accordance with the hardware configuration of the verification apparatus 100, the type of program, or the like, which will be described below.

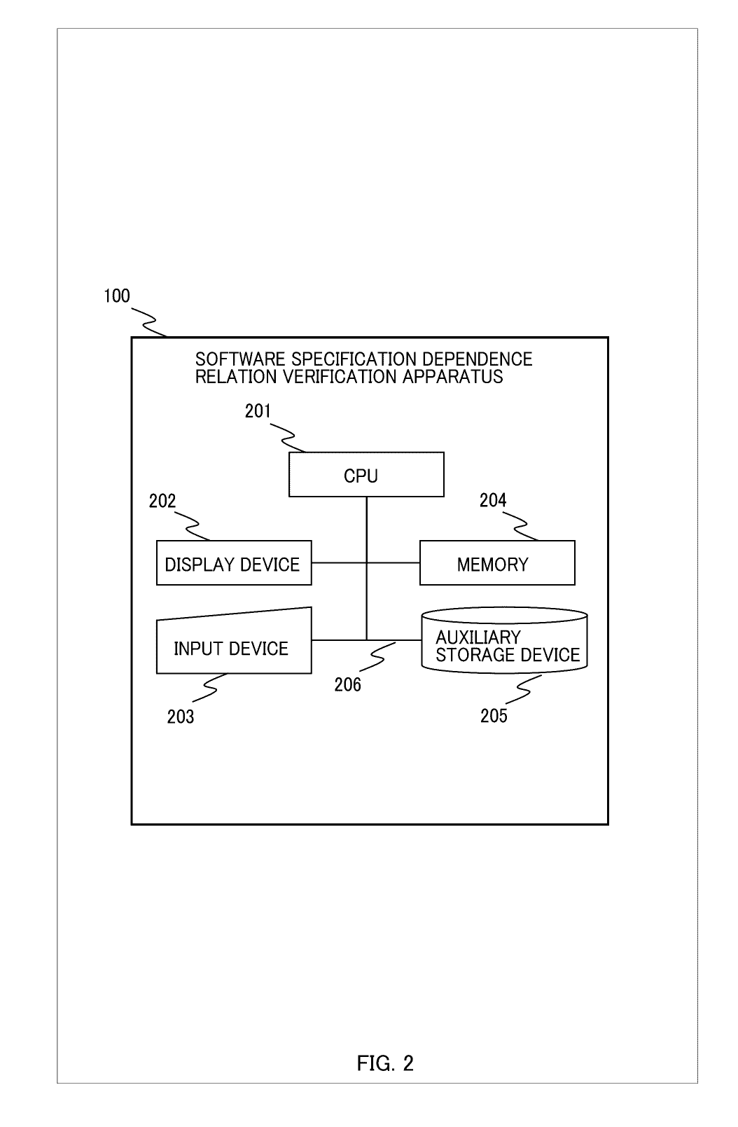

Next, a hardware configuration of the verification apparatus 100 of the present embodiment will be described. FIG. 2 illustrates an exemplary hardware configuration of the verification apparatus 100 of the present embodiment. As illustrated in FIG. 2, the verification apparatus 100 includes a processor 201, a display device 202, an input device 203, a memory 204, and an auxiliary storage device 205, which are communicably connected with each other via an internal network 206. The processor 201 is a computing device such as a CPU (Central Processing Unit) configured to read, into the memory 204, programs (respective processing units of FIG. 1) and data (software specifications to be verified stored in respective DBs and the specification DB 101 of FIG. 1) being held in the auxiliary storage device 205, and perform processes relating to specification management and mismatch verification. The display device 202 is an output device for displaying the result of processing by the CPU 201, for which a monitor display, or the like, of an appropriate form is used. The display device 202 may have an audio output device included therein. The input device 203 is a device for inputting execution requests to the processing unit, or design content for a template being displayed, for which a keyboard, a mouse, a touch panel, or the like is employed as appropriate. The memory 204, which is a main storage device such as a RAM (Random Access Memory), reads and holds therein programs and data to be executed by the CPU 201. The auxiliary storage device 205 is a storage device such as an HDD (Hard Disk Drive) or an SSD (Solid State Drive) configured to hold programs (respective processing units of FIG. 1) and data (respective DBs of FIG. 1) required for performing data processing by the verification apparatus 100.

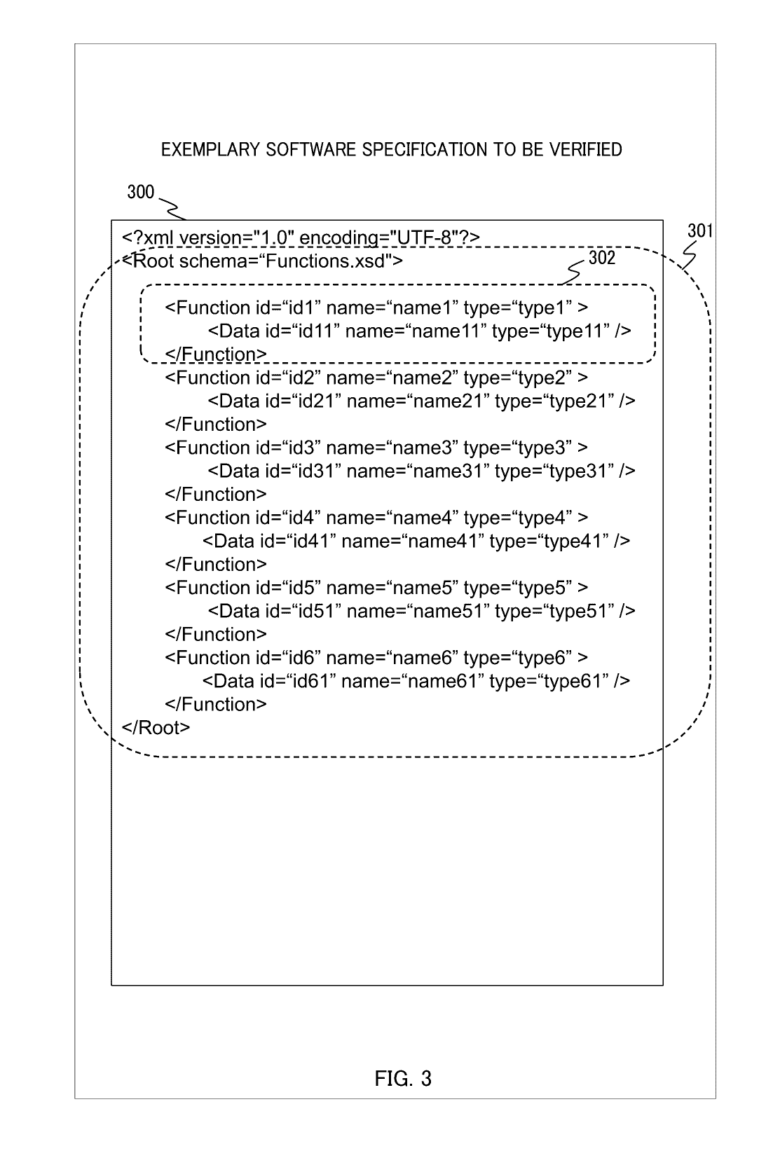

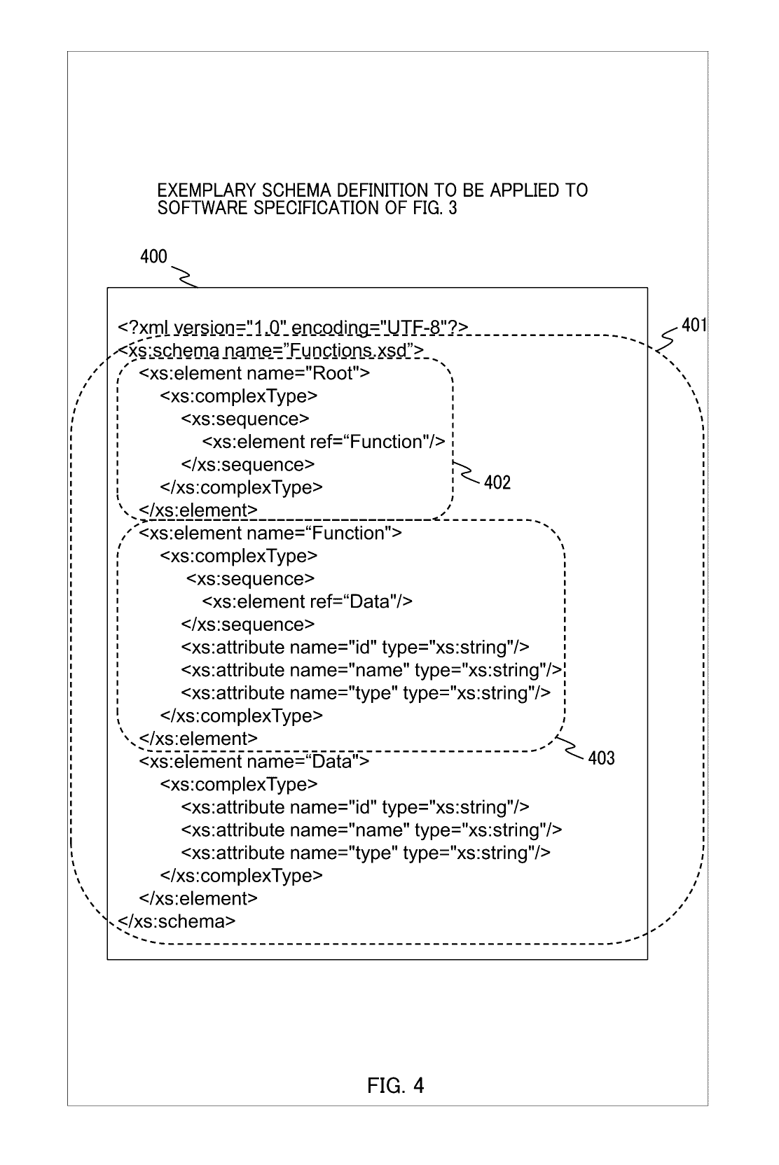

Next, a software specification (“specification”, in the following) subject to a specification dependence relation verification process by the verification apparatus 100 of the present embodiment will be described. FIG. 3 illustrates an exemplary structured specification 300 to be verified by the verification apparatus 100. In FIG. 3, a specification expressed in XML (eXtensible Markup Language) is illustrated as a specific example. Data of the specification 300 to be verified is input to the verification apparatus 100 by a user performing the verification process, and stored in the specification DB 101 of the verification apparatus 100 illustrated in FIG. 1. The specification 300 is a document which expresses a list of functions exerted by the software defined in the specification. The specification expresses the meaning of specification items in the form of XML tags. The specification 300 is a program expressing, in the form of a list, that respective functions have assigned thereto “Data” having respective attributes “id”, “name” and “type”, as indicated by the surrounding dashed lines with symbols 301 and 302. In the specification, a file reference path of a schema definition defining the structure of the specification in a Root schema is first specified as “Root/Functions”, as indicated by the symbol 301. Specifying a schema definition file (FIG. 4) to be applied in the specification 300 in the above manner allows the type and structure of the specification to be determined. Here, the specification 300 is not limited to a particular form as long as it is structured in a manner that the specification items held therein can be identified. For example, the present invention can also be applied to a specification in the form of a list or diagram, similarly to the XML example, by assigning the specification items to rows and columns of a list, or shapes of a diagram.

Next, a schema definition defining the structure of the specification 300 will be described. FIG. 4 illustrates an exemplary schema definition 400 defining the structure of the specification 300 illustrated in FIG. 3. The schema definition 400 is input to the verification apparatus 100 by a user, and stored in the schema definition DB 102 of the verification apparatus 100 illustrated in FIG. 1. In FIG. 4, the schema definition 400 expressed by an XML Schema will be described as a specific example. The XML Schema is a language for defining the hierarchical structure of the specification 300 and, as indicated by the symbol 401 in the example of FIG. 4, a schema with the “schema name” being “Functions” is first associated with the specification 300 of FIG. 3. The schema then expresses that the “Root” item has a “Function” item as a child element as indicated by the symbol 402, and “Function” item includes a “Data” item and respective “Data” items have the “id” attribute, the “name” attribute and the “type” attribute, as indicated by the symbol 403. The specification 300 has to be described according to the structure defined in the schema definition 400.

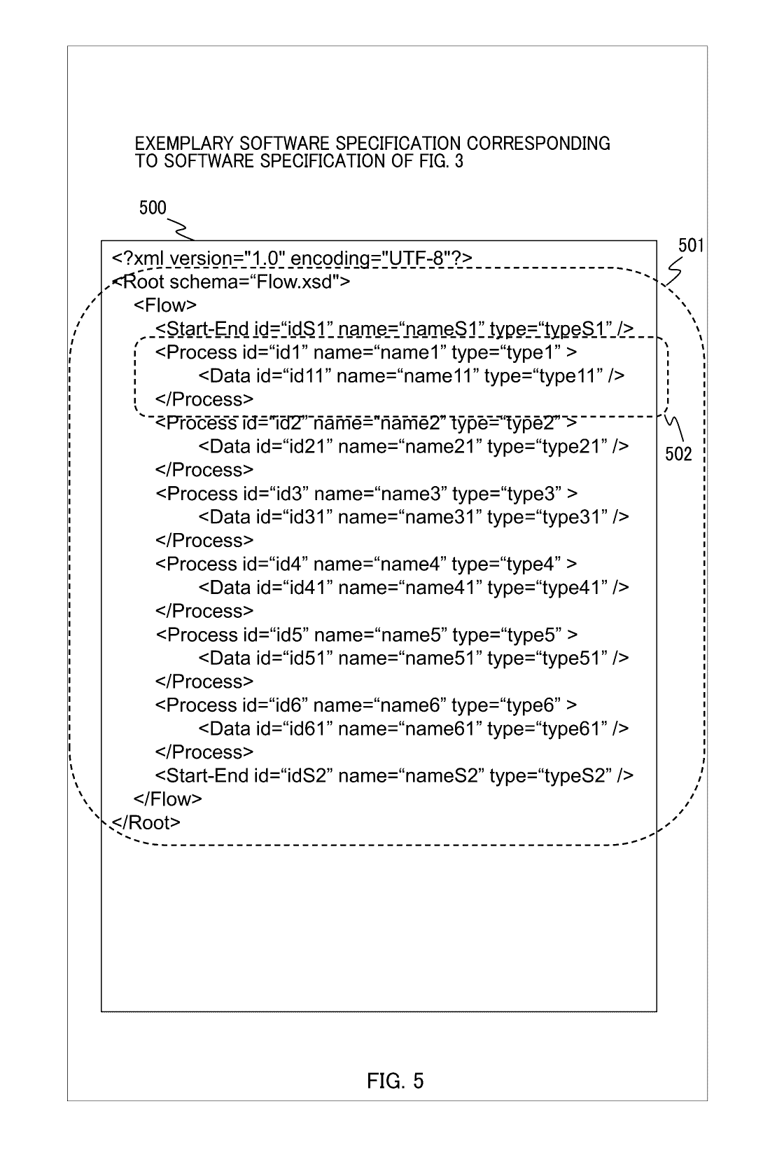

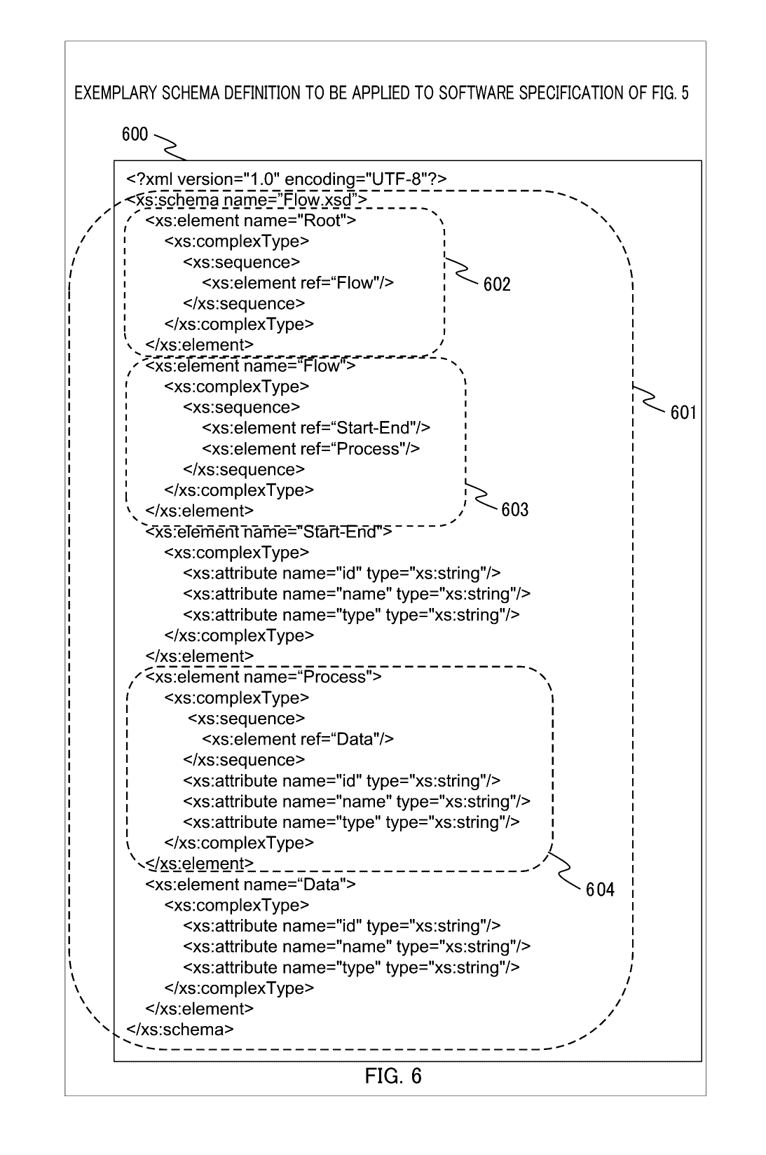

Next, FIGS. 5 and 6 illustrate examples of a specification 500 expressed by XML and a schema definition 600 defining the specification structure thereof, similarly to FIGS. 3 and 4. The specification 500 illustrated in FIG. 5 is a specification for expressing the flow of data processing as a process flow including a plurality of functions with the Root schema being defined as “Flow” (symbol 501), and is regarded as a specification having a dependence relation with the specification 300 of FIG. 3 expressing the corresponding software functions in the form of list. The type of dependence relation existing between the specification 300 and the specification 500 will be described below. The specification 500 of FIG. 5 is a program expressing, in the form of a flow, that respective processes (corresponding to the functions of FIG. 3) included in the “Flow” item have assigned thereto “Data” having respective attributes “id”, “name” and “type”, as indicated by the surrounding dashed lines with symbols 501 and 502. To describe the foregoing in correspondence with the schema definition 600 associated with the “schema name” being “Flow” (symbol 601), the specification 500 expresses that first the “Root” item has a “Flow” item as a child element (symbol 602), the “Flow” item further has a Process item as a child element (symbol 603), and the “Process” item has a “Data” item, a “id” attribute, a “name” attribute and a “type” attribute. In the specification 500, the file reference path of the schema definition defining structure of the specification by the Root schema is specified as the “Root/Flow”. The data path specifying respective specification items, namely, the “id” attribute, the “name” attribute, and the “type” attribute is defined as the “Root/Flow/Process”.

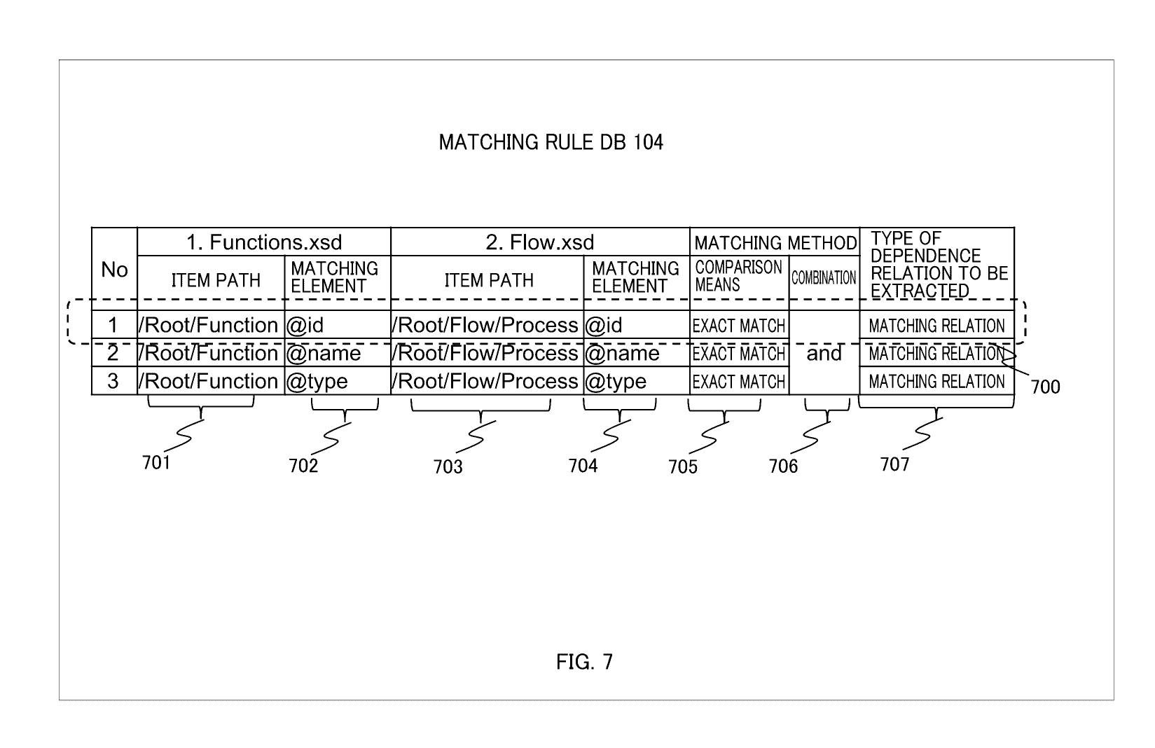

Next, respective DBs installed in the verification apparatus 100 of the present embodiment will be described. First, the matching rule DB 104 will be described. FIG. 7 illustrates an exemplary configuration of the matching rule DB 104 having stored therein matching rules 700 describing an extraction method of the dependence relation between the specifications 300 and 500 illustrated in FIGS. 3 and 5. The matching rules 700 stored in the matching rule DB 104 describe a dependence relation extraction method between two schema definitions 400 and 600. The matching rules 700 illustrated in FIG. 7 describe descriptions 701 and 702 relating to the schema definition 400 illustrated in FIG. 4, and descriptions 703 and 704 relating to the schema definition 600 illustrated in FIG. 6, respectively. The description relating to the respective schema definitions 400 and 600 describes paths 701 and 703 of items for specifying specification items subject to dependence relation extraction at relative positions in respective specifications, and matching elements 702 and 704 as information for determining the presence or absence of dependence relation. In addition, the matching method describes comparison means 705 and a combination 706 of specification items. In FIG. 7, three elements, namely, “id”, “name” and “type” are extracted from the schema definitions 400 and 600 of the specifications 300 and 500 as the matching elements 702 and 704. The comparison means 705 describes a condition that holds between the values included in the respective matching elements 702 and 704 such as, for example, “exact match”, “partial match”, or “match by particular conversion”. The combination 706 describes a simultaneous or exclusive establishment condition of the matching rules 700 described across a plurality of rows in the form of “and” or “or”, for example. The type name of the dependence relation that can be extracted is described in the dependence relation type 707 to be extracted, when it is determined that there exists a dependence relation according to the comparison by the matching methods 705 and 706. In the example of FIG. 7, a “matching relation” is defined as a relation that two items 702 and 704 are completely the same. There may also be conceivable various dependence relations, in terms of the relation between a function and data, for example, such as the exclusive lock/shared lock relation, or CRUD (Create, Read, Update, Delete) relation. Here, the type of dependence relation used herein is used for a dependence relation verification process described below. Specifically, in the example of the matching rules 700 of FIG. 7, there is defined a rule which determines that there exists a dependence relation named “matching relation” between two items, when the attribute values of the Function item at and below the Root item of the specification 300 illustrated in FIG. 3 and the attribute values of the Process item at and below the Flow item at and below the Root item of the specification 500 illustrated in FIG. 5 exactly match in terms of the id attribute, name attribute and type attribute, respectively.

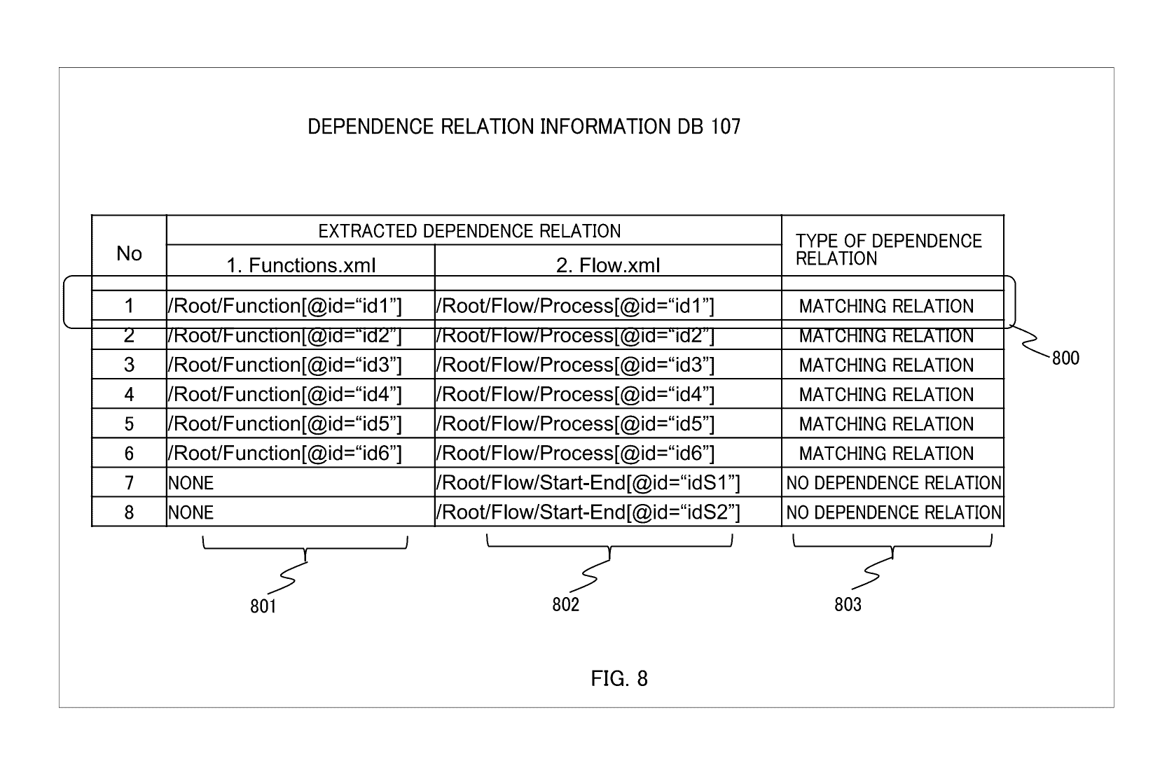

Next, the dependence relation information DB 107 will be described. FIG. 8 illustrates an exemplary configuration of the dependence relation information DB 107 having stored therein the dependence relation between respective specification items 801 of the specification 300 of FIG. 3 extracted using the matching rules 700 of FIG. 7 and respective specification items 802 of the specification 500 of FIG. 5, in an associated manner. A search is performed for each and every specification item included in the specifications 300 and 400, and all the dependence relations between specification items determined to match the matching rules 700 defined in the matching rule DB 104 and thus extracted are stored in the dependence relation information DB 107 in association with the dependence relation type 803. In the example of FIG. 8, “Start-End”, which is a specification item described with regard to the specification “Flow”, is not described with regard to the specification “Functions”. When it is determined in the above manner that a specification item corresponding to a specification item existing in one of the specifications does not exist on the other specification, the missing specification item is extracted in the dependence relation verifying unit 109 described below as dependence relation candidate information, which is information indicating a suspicious mismatch of specification items, and can be presented to a user via the verification relation visualization unit 110.

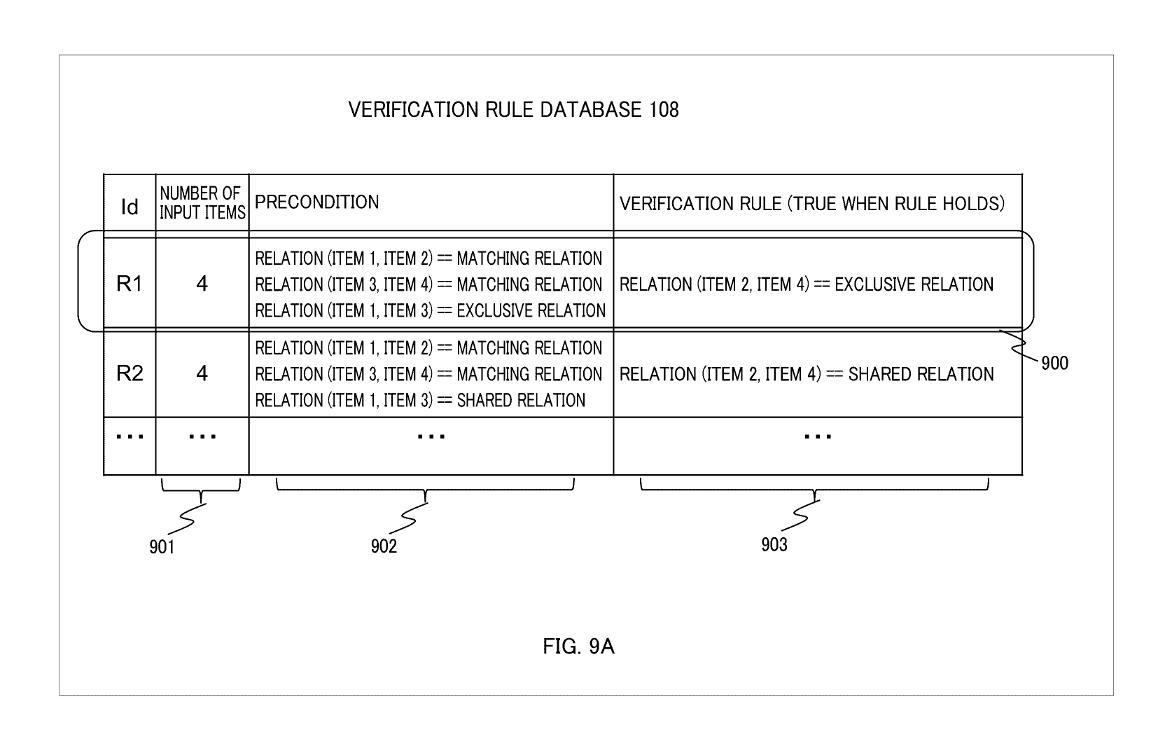

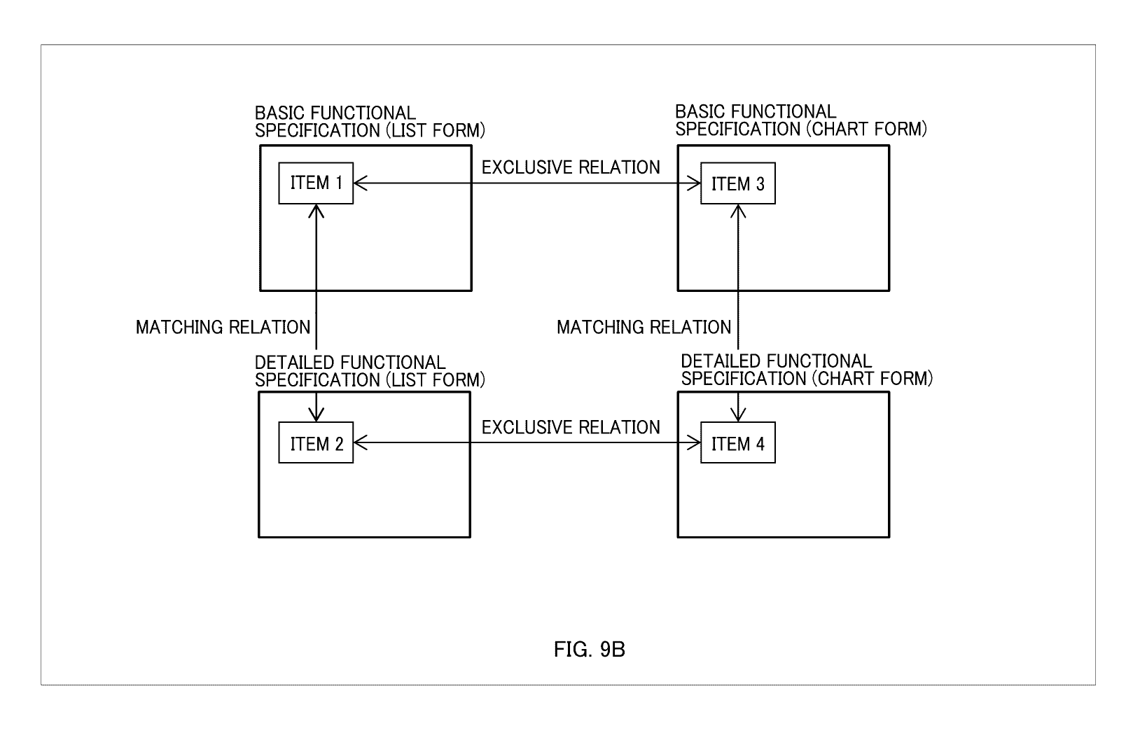

Next, the verification rule DB 108 will be described. FIG. 9A illustrates an exemplary configuration of the verification rule DB 108 having stored therein verification rules 900 listing the conditions supposed to simultaneously hold between the types of dependence relation. The verification rules 900, which are rules defined for detecting mismatches between specifications, are identified in FIG. 9A by symbols, such as R1, R2, . . . . When it is determined that there exists a dependence relation that does not satisfy any of the verification rules 900, a contradiction is determined to exist between dependence relations and detected as a mismatch. First, the number of input items 901 required for verification and a precondition 902 for the input item are described. The precondition 902 is used to narrow down the specifications that can be verified. In other words, only the specifications satisfying the precondition are regarded as specifications that can be verified, and a check is performed according to the verification rule 903. When verification is performed, specifications satisfying both the precondition 902 and the verification rule 903 are determined to be matched whereas those satisfying the precondition 902 but not satisfying the verification rule 903 are determined to be mismatched.

Specifically, with four specification items having been input, there is defined as a first rule R1 in the verification rule DB 108 of FIG. 9 that when there exists a “matching relation” between the item 1 and item 2, and between the item 3 and item 4, respectively, and an “exclusion (lock) relation” between the item 1 and item 3, there should also exist an “exclusion (lock) relation” between the item 2 and item 4, each of which being in a “matching relation” with the item 1 and item 3, respectively. This is a rule for detecting a definition with a contradicting dependence relation such that whereas an exclusive relation is defined for one item, another item being in a matching relation therewith is defined not to be in an exclusive relation (e.g., to be in a shared relation). There is no limit on the number of input items, and thus the number of input items 901 required for describing the verification rule is supposed to be defined. Specifying the number of input items allows as many number of parts of the precondition 902 and the verification rule 903 to be used for definition in the form of “item+number”. When verification is actually performed, as many specification items as the specified number are prepared and input to the “item+number” part and then verification is performed. Here, the description “relation (item 1, item 2)” used in the precondition 902 and the verification rule 903 in the verification rule DB 108 of FIG. 9A has a function of searching the already extracted dependence relation information 800 illustrated in FIG. 8 to detect a matching row, and returning the value of a dependence relation type 803 defined therein. Respective verification rules 900 are preliminarily set as relations supposed to hold between respective specification items included in corresponding specifications. FIG. 9B schematically illustrates the meaning of the verification rules 900 illustrated in FIG. 9A. FIG. 9B illustrates a rule (corresponding to the rule R1 of FIG. 9A) that when an exclusive relation has been set between the corresponding item 1 and item 3, with the same basic functional specifications being correspondingly expressed in the forms of a list and a chart, an exclusive relation must also be set between the corresponding item 2 and item 4 in detailed functional specifications obtained by breaking down respective components thereof.

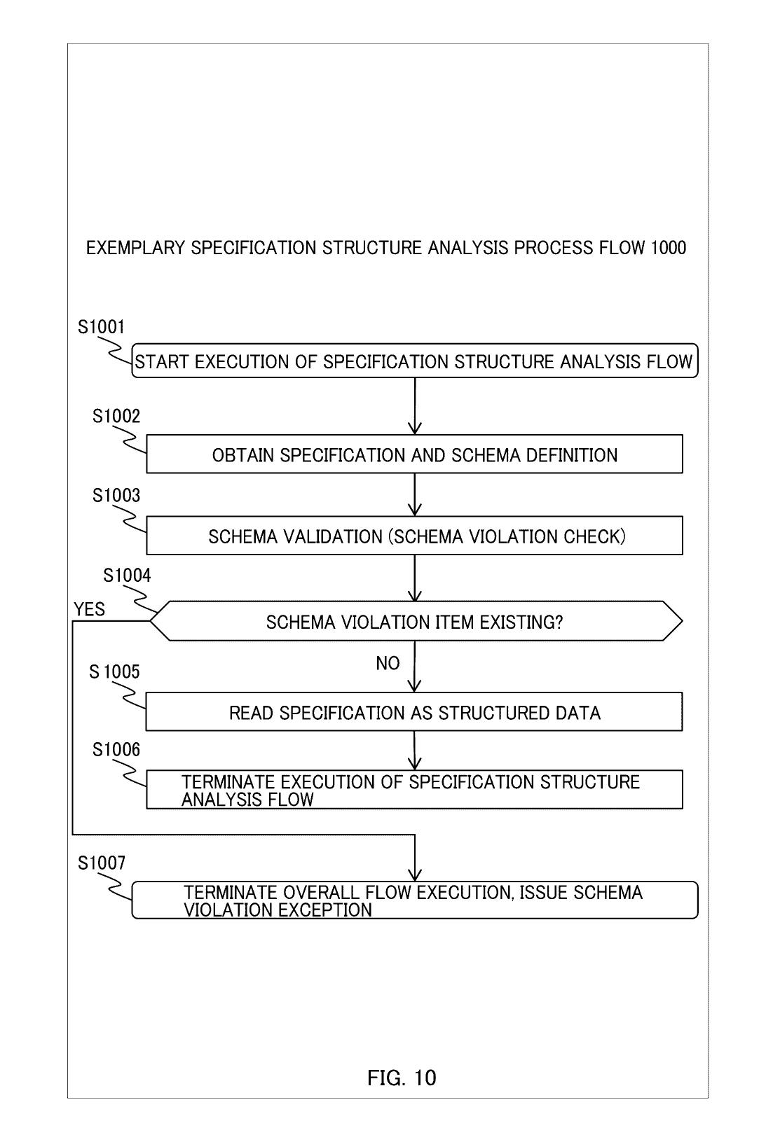

Next, data processing performed in respective processing units in the verification apparatus 100 of the present embodiment will be specifically described. First, a specification structure analysis process in the specification structure analysis unit 103 will be described. FIG. 10 is a flowchart illustrating an exemplary specification structure analysis process flow in the specification structure analysis unit 103. The specification structure analysis process performs a process of reading a specification file to be analyzed into the memory as structured data. Assuming that activation of the overall process flow of the verification apparatus 100 has been triggered by powering or the like on the verification apparatus 100, the specification structure analysis unit 103 first starts processing at 51001, and thereafter obtains a specification and a schema definition defining the structure of the specification respectively from the specification DB 101 and the schema definition DB 102 stored in the auxiliary storage device 205 (S1002). The specification and the schema definition obtained in the present embodiment correspond to, for example, the specifications 300 and 500, and the schema definitions 400 and 600. Next, the specification structure analysis unit 103 confirms by schema validation that there does not exist a description violating the schema definition in the obtained specification (S1003). Schema validation can be realized by a general XML validation technique when the specification is XML and the schema definition is XML Schema, for example, and therefore detailed description thereof is omitted here. Subsequently, the specification structure analysis unit 103 determines, as a result of confirmation at S1003, whether or not there exists an item violating the schema definition (S1004) and, when it is determined that there exists an item violating the schema definition (Yes at S1004), the overall process flow is terminated and an exception is issued (S1007) because it is impossible to read the specification correctly. When it is determined that there does not exist an item violating the schema definition (No at S1004), the specification is read into the memory as described in the schema structure (S1005), and execution of the specification structure analysis flow is terminated (S1006). The specification structure analysis process causes a specification subject to specification dependence relation verification to be read into the verification apparatus 100 as structured data.

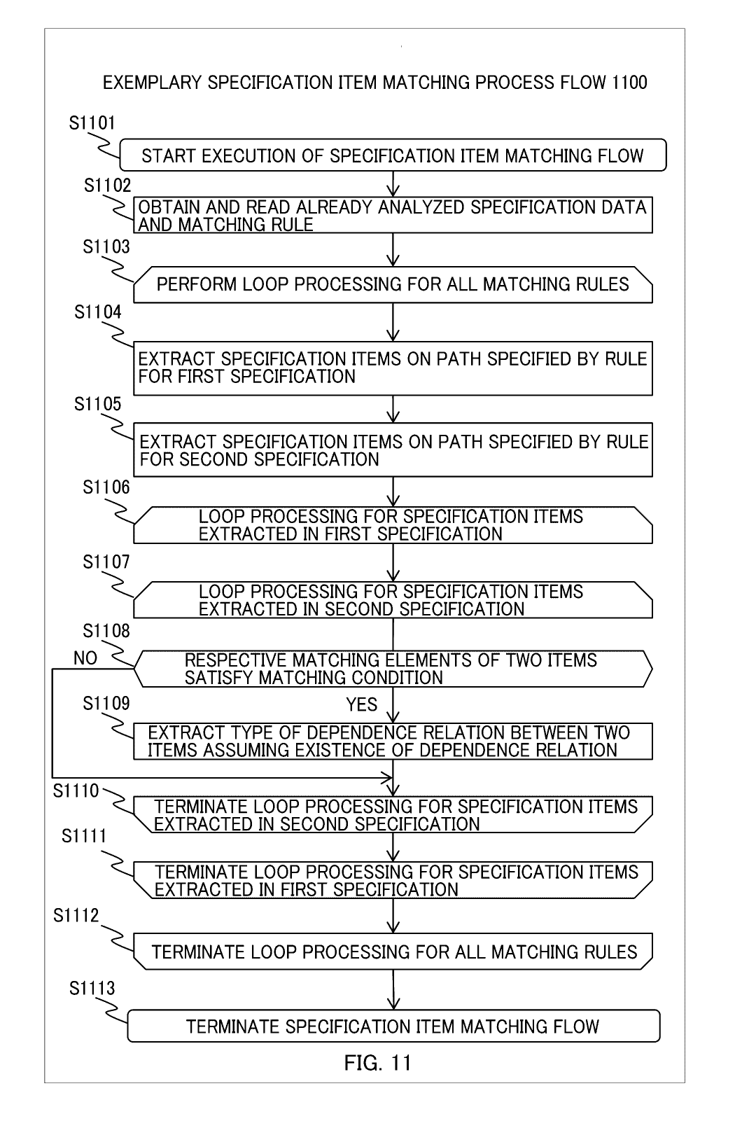

Next, a specification item matching process will be described. FIG. 11 is a flowchart illustrating an exemplary process flow of the specification item matching process performed by the specification item matching unit 105. The specification item matching process determines whether or not there exists a dependence relation between specification items included in the specification already extracted in the specification structure analysis process and, when there exists a dependence relation, performs a process of extracting it as dependence relation information. After the process is started at S1101, the specification item matching unit 105 first obtains already analyzed specification data from the specification structure analysis unit 103, and obtains and reads the matching rules 700 describing a dependence relation establishment condition between specification items from the matching rule DB 104 (S1102). Subsequently, the specification item matching unit 105 performs loop processing, for all the matching rules 700 stored in the matching rule DB 104, of extracting dependence relation satisfying the rules (S1103 to S1112). In each loop process, the specification item matching unit 105 extracts all the sets of specification items specified in the path of the items for the first specification (the specification 300 of FIG. 3 in the present embodiment) described in one of the matching rules 700 from the specification data (S1104). In addition, the specification item matching unit 105 extracts all the sets of the specification items specified in the path of the items for the second specification (the specification 500 of FIG. 5 in the present embodiment) similarly from the specification data (S1105). Subsequently, the specification item matching unit 105 performs loop processing for all the specification items extracted in the first specification (S1106 to S1111), and similarly performs loop processing for all the specification items extracted in the second specification (S1107 to S1110). The specification item matching unit 105 determines in each loop processing whether or not the respective matching elements 702 and 704 of two specification items (e.g., attributes in specification items) satisfy the condition that is described in the matching methods 705 and 706 (S1108). When it is determined that the matching condition is satisfied and there exists a dependence relation (Yes at S1108), the specification item matching unit 105 sets the path information of the two items and the type of dependence relation in the dependence relation information DB 107 as dependence relation information between the two items (S1109). When it is determined that the matching condition is not satisfied (No at S1108), the specification item matching unit 105 performs the next loop processing because there is no dependence relation (S1106, S1107). At the point where the processing is completed for all the matching rules 700 and all the dependence relation information have been obtained (S1112), the specification item matching process flow is terminated (S1113).

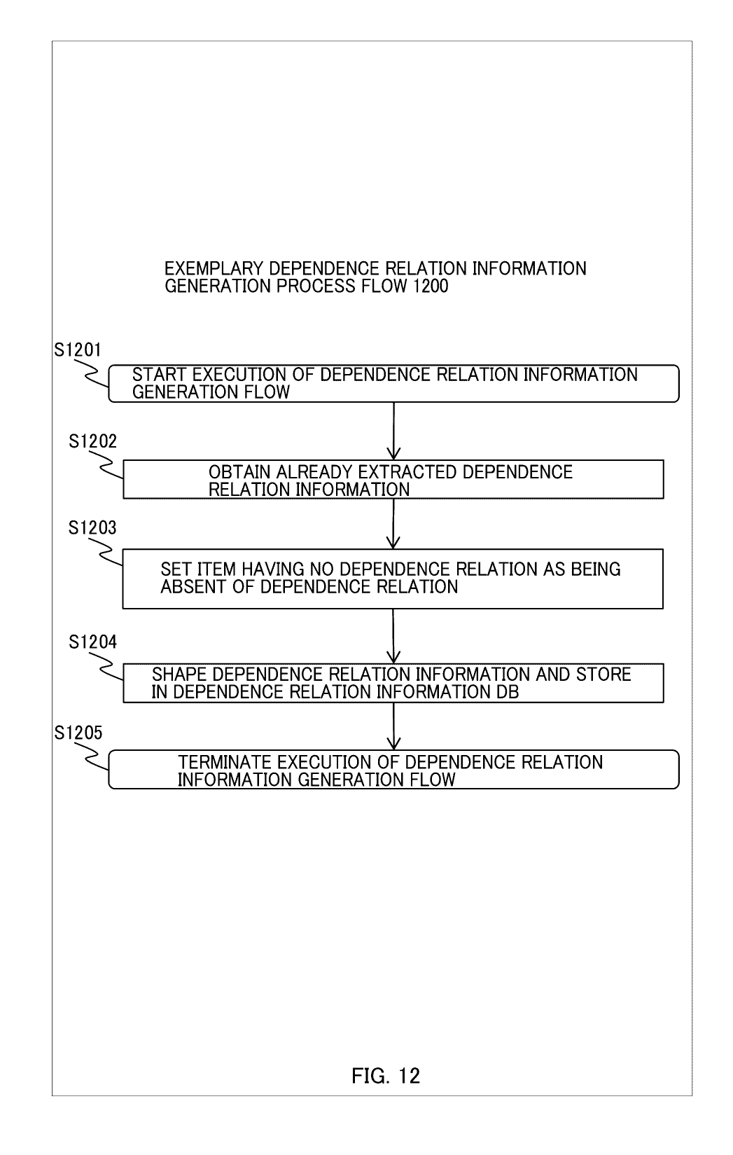

Next, a dependence relation information generation process will be described. FIG. 12 is a flowchart illustrating an exemplary process flow of a dependence relation information generation process 1200 performed by the dependence relation information generating unit 106. The dependence relation information generation process is a process of shaping the dependence relation information extracted in the specification item matching process 1100 and storing the resulting information in the dependence relation information DB 107. After the process is started at S1201, the dependence relation information generating unit 106 first obtains the already extracted dependence relation information (S1202), and sets a specification item having no dependence relation as being absent of dependence relation (S1203). Subsequently, the dependence relation information generating unit 106 shapes the dependence relation information into an information in a storage format of the dependence relation information DB 107 illustrated in FIG. 8, stores the resulting information in the dependence relation information DB 107 (S1204), and the dependence relation information generation process flow is terminated (S1205).

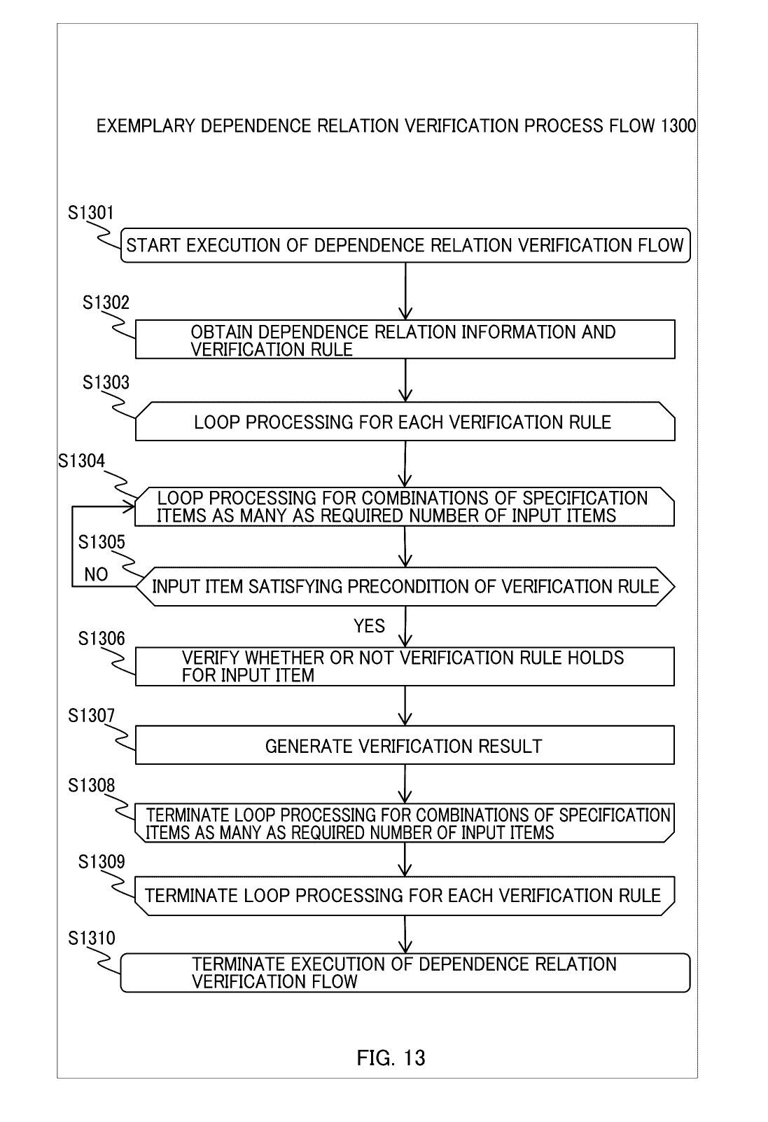

Next, a dependence relation verification process will be described. FIG. 13 is a flowchart illustrating an exemplary process flow 1300 of the dependence relation verification process performed by the dependence relation verifying unit 109. Using a verification rule 900 having predefined therein dependence relation information and matching conditions supposed to hold between specifications in a form of a rule, the dependence relation verification process verifies whether or not there exists a dependence relation violating the verification rules 900 between dependence relation information and, when it is determined that there exists a violation, the violation is extracted and output as a mismatch between specifications. After the process is started at S1301, the dependence relation verifying unit 109 first obtains dependence relation information from the dependence relation information DB 107, and obtains the verification rules 900 from the verification rule DB 108 (S1302). Subsequently, the dependence relation verifying unit 109 performs loop processing for each of the verification rules 900 obtained (S1303 to S1309). In the loop processing for each of the verification rules 900, all the combinations of specification items as many as the required number of input items are generated for one of the verification rules 900, and the loop processing is performed for all the combinations (S1304 to S1308). In the loop processing of the specification item combinations, the dependence relation verifying unit 109 determines whether or not an input item satisfies a precondition of the verification rules 900 (whether or not a predetermined matching relation or exclusive relation holds, in the exemplary rule R1 of FIG. 9A) (S1305). When it is determined that the input item does not satisfy the precondition 902 (No at S1305), the current one of the verification rules 900 cannot be applied and therefore similar determination process is performed for the next one of the verification rules 900 (S1304). When it is determined that the input item satisfies the precondition 902 of the verification rules 900 (Yes at S1305), the dependence relation verifying unit 109 verifies whether or not the verification rule 903 holds for the input item (S1306). The verification result is generated in accordance with the dependence relation information (S1307) so that the verification result indicates absence of mismatch when it is determined that the verification rule 903 holds, or the verification result indicates presence of a mismatch when it is determined that the verification rule 903 does not hold. When it is determined that the loop processing of specification item combinations is completed (S1308), the dependence relation verifying unit 109 performs loop processing for the specification item combinations for next one of the verification rules 900 again (S1304). At the point where the loop processing is completed for all verification rules 900 stored in the verification rule DB 108 (S1309), the dependence relation verifying unit 109 terminates execution of the dependence relation verification process flow 1300 (S1310). According to the aforementioned dependence relation verification process, it is possible to verify whether or not a predetermined dependence relation holds between corresponding specifications. Note that, when the same precondition 902 has been set in a different one of the verification rules 900, it is not necessary to repeatedly perform the determination process on the precondition 902. From this viewpoint, it is also conceivable to use an existing determination result, if any, for the same precondition 902, with the determination result for a particular precondition 902 preliminarily stored in the memory 204 or the like.

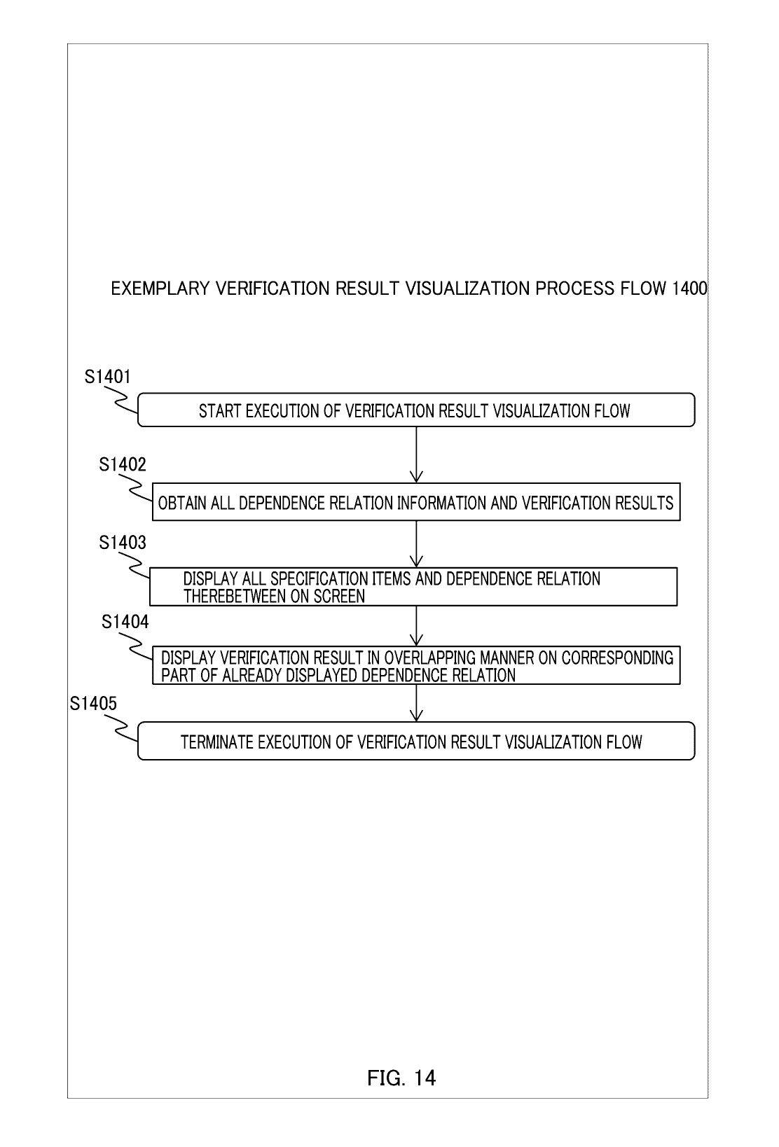

Next, a verification result visualization process will be described. FIG. 14 is a flowchart illustrating an exemplary process flow of the verification result visualization process 1400 performed by the verification result visualization unit 110. The verification result visualization process displays the extracted dependence relation and also displays the mismatch part which does not satisfy the verification rules 900 in an emphasized manner, so as to comprehensibly present to the user the part between specifications at which a mismatch has occurred. After the process is started at S1401, the verification result visualization unit 110 first obtains all the dependence relation information and all the dependence relation verification results stored in the dependence relation information DB 107 (S1402). Using the obtained dependence relation information 800, the verification result visualization unit 110 first displays all the specification items and the dependence relation information therebetween (S1403), displays the verification result in an overlapping manner on the corresponding part of the dependence relation being displayed (S1404), and terminates execution of the verification result visualization process flow (S1405). The verification result visualization process makes it possible to immediately and visually grasp a mismatch, if any, that has occurred between specifications.

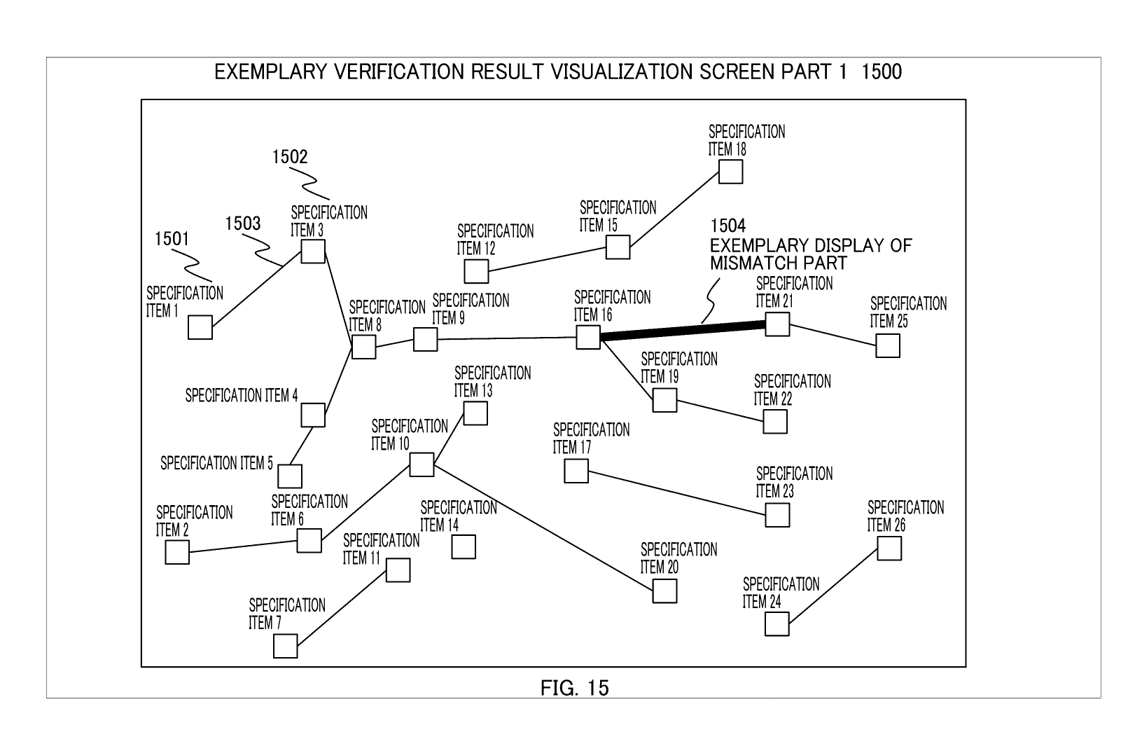

FIG. 15 illustrates an exemplary result of the verification result visualization process illustrated in FIG. 14. FIG. 15 is a sample of a screen 1500 displaying an example of performing the verification result visualization via a user interface employed in the verification apparatus 100 of the present embodiment. Having displayed thereon all the dependence relations stored in the dependence relation information DB 107 on the display device 202, the verification result visualization screen 1500 displays the verification result in an overlapping manner on the corresponding part. Referring to the example of FIG. 15, specification items, such as a specification item 1 (1501) and a specification item 3 (1502), are placed at arbitrary positions on the screen, and specification items having dependence relations are coupled by lines, referring to the dependence relation information DB 107 (1503). Accordingly, a dependence relation diagram in the form of a network illustrated in FIG. 15 is generated. Furthermore, the part determined to be mismatched is displayed in an emphasized manner over the dependence relation diagram (1504), referring to the verification result obtained by applying the verification rules 900, so that the user can recognize at first sight which part of the entire specification has a mismatch.

Note that, in a case where displaying all the dependence relation information simultaneously on the screen results in an excessive amount of presentation to an annoying degree, it is also conceivable to replace the process flow illustrated in FIG. 14 by first displaying only minimal dependence relations selected by the user, and extracting and displaying, in a daisy-chained manner, only the dependence relations relating directly or indirectly to the minimal dependence relations which are the dependence relations sharing the same specification items. Accordingly, it is possible to omit displaying dependence relations which are irrelevant to the part subject to dependence relation verification, whereby cluttered display on the screen can be avoided.

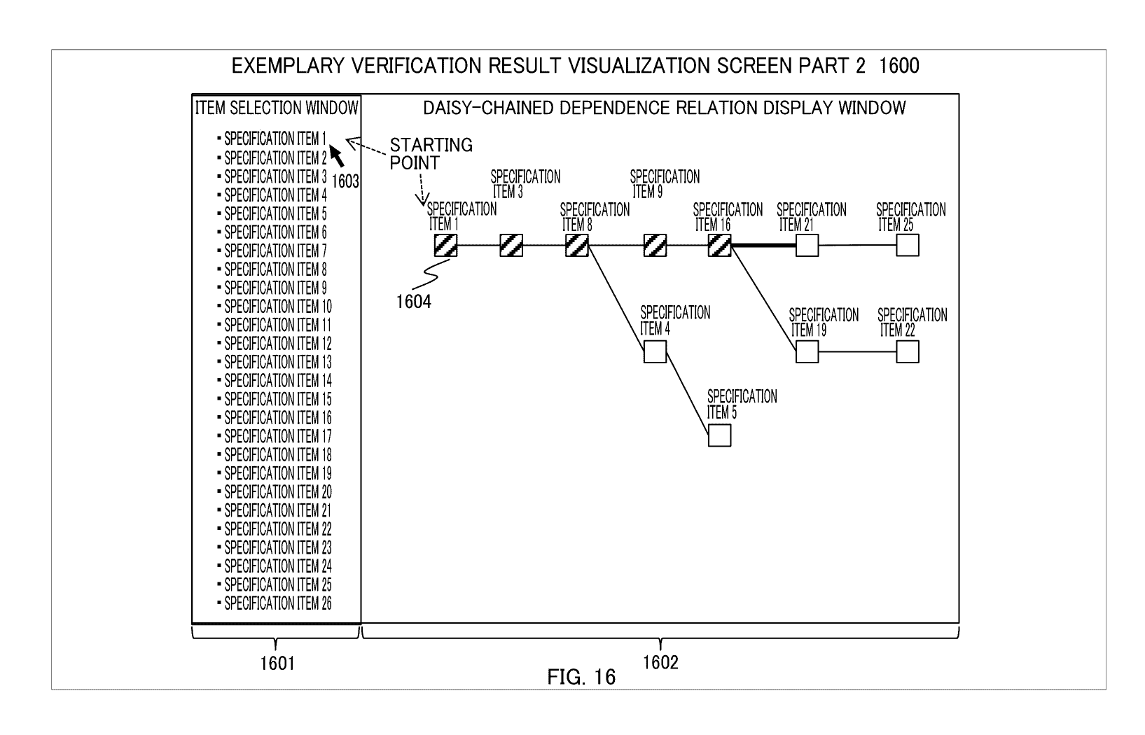

FIG. 16 is a screen sample illustrating an exemplary verification result visualization which extracts and displays a part of the aforementioned dependence relations in a daisy-chained manner. A verification result visualization screen 1600 can be used to visualize only minimal dependence relation information in a case where displaying all the dependence relations as illustrated in FIG. 15 results in a large number of displayed items and dependence relation lines which are complexly intertwined and difficult to confirm. The verification result visualization screen 1600 illustrated in FIG. 16 is configured to include an item selection window 1601 and a daisy-chain dependence relation display window 1602. The item selection window 1601 is configured to display all the specification items included in the dependence relation information DB 107 thereon in the form of list, allowing a user of the verification apparatus 100 to select any of the specification items by clicking or the like on an object on the screen (1603). The item selection window 1601 is configured so that when a user selects any of the specification items, the selected specification item is defined as a starting point (1604) and specification items associated with the starting point specification item on the basis of dependence relations are extracted in a daisy-chain manner. The dependence relations extracted in the aforementioned manner are displayed as a tree structure in the daisy-chain dependence relation display window 1602. Accordingly, only the dependence relations within a range in which the user desires to confirm the verification result are retrieved and displayed without the tree-structured dependence relation lines being complexly intertwined, whereby the user can check dependence relations with regard to desired specification items in a shorter time. Note that, it is also conceivable to display, in an emphasized manner, specification items existing along a path from the starting point specification item to the specification item at a point of mismatch, for example, in order to systematically indicate where a mismatch exists across the dependence relations extracted in a daisy-chain manner, whereby the verification result can be presented to the user in a more comprehensible manner.

As has been described above, according to the specification dependence relation verification apparatus 100 of the present embodiment, it can be readily confirmed whether or not there exist dependence relations between respective specification items included in the corresponding specifications 300 and 500 without redundancy or inadequacy. In addition, it is also easy to discover mismatches occurring between dependence relations existing between corresponding specification items.

Note that, the present invention is not limited to the aforementioned embodiments, and may include various variations thereof. For example, the aforementioned embodiments are described in detail to explain the present invention comprehensibly, and are not limited to those including all the components described above. In addition, a part of the components of the embodiments may be replaced by other components, or other components may be added to the components of a certain embodiment.

### REFERENCE SIGNS LIST

100 . . . specification dependence relation verification apparatus
101 . . . specification DB
102 . . . schema definition DB
103 . . . specification structure analysis unit
104 . . . matching rule DB
105 . . . specification item matching unit
106 . . . dependence relation information generating unit
107 . . . dependence relation information DB
108 . . . verification rule DB
109 . . . dependence relation verifying unit
110 . . . verification result visualization unit
201 . . . processor
202 . . . display device
203 . . . input device
204 . . . memory
205 . . . auxiliary storage device

1. A software specification consistency verification apparatus for verifying consistency of specification items that are data items included in software specifications having a hierarchical structure, the software specification consistency verification apparatus comprising:
a specification structure analysis unit configured to obtain at least a pair of software specifications corresponding to each other, and extract the respective specification items whose relative positions in the software specifications are preliminarily set in accordance with the hierarchical structure;
a matching rule storage unit having stored therein matching rules describing a dependence relation, wherein the dependence relation is a correspondence relation between the specification items included in the software specifications;
a specification item matching unit configured to determine, using the matching rules, whether or not there exists a dependence relation between the specification items;
a dependence relation information generating unit configured to extract dependence relation information identifying the specification items determined by the specification item matching unit to have the dependence relation;
a verification rule storage unit having stored therein verification rules defining matching conditions between the software specifications for a particular combination of the specification items;
a dependence relation verifying unit configured to:
determine whether or not there exists a dependence relation which does not satisfy the matching condition defined in the verification rules stored in the verification rule storage unit for the identified specification items on the basis of the extracted dependence relation information and,
in response to a determination that there exists a dependence relation that does not satisfy the matching condition, output the dependence relation that does not satisfy the matching condition as mismatch information indicating a mismatch between the software specifications; and
a verification result output unit configured to output, via a predetermined user interface, the mismatch information from the dependence relation verifying unit.

2. The software specification consistency verification apparatus according to claim 1, wherein the dependence relation information generating unit, upon determining that there exists in one of the software specifications a specification item satisfying the matching rules and there does not exist in the other one of the software specifications a specification item satisfying the matching rules when extracting dependence relation information between the software specifications in accordance with the matching rules, is configured to extract the specification item satisfying the matching rules as dependence relation candidate information, and the dependence relation verifying unit detects a candidate mismatch, using the verification rules described using the dependence relation information and the dependence relation candidate information.

3. The software specification consistency verification apparatus according to claim 1,
wherein the matching rules include dependence relation type information indicating, for each of the matching rules, a type of dependence relation defined by the matching rule;
wherein the verification rules include logic conditions supposed to be satisfied between a plurality of the dependence relation types;
wherein the dependence relation information generating unit extracts presence or absence of dependence relation between specification items as dependence relation information and also types of the dependence relation, when extracting the dependence relation information;
wherein the dependence relation verifying unit detects a mismatch between the dependence relation types between the specification items, on the basis of the logic conditions supposed to be satisfied between a plurality of the extracted dependence relation types.

4. The software specification consistency verification apparatus according to claim 1, wherein the verification result output unit is configured to display the extracted dependence relation information in a form that visualizes relations between specification items having dependence relations, and is configured to display, in an overlapping manner, the detected mismatch information on the relations between the specification items being displayed.

5. The software specification consistency verification apparatus according to claim 4, wherein the verification result output unit, when displaying the extracted dependence relation information, is configured to:
display, in a selectable manner, the specification items included in the specifications to be verified,
analyze a plurality of pieces of the extracted dependence relation information with the selected specification item being a starting point, and
extract and display all specification items having a direct or indirect dependence relation with the specification item being the starting point.

6. The software specification consistency verification apparatus according to claim 5, wherein the verification result output unit, when displaying the detected mismatch information in an overlapping manner on a dependence relation displayed in association with the selected specification items, is configured to display, in a manner that allows for identifying the specification items, coupling items ranging from the specification item being the starting point to a part of the dependence relation determined to be a mismatch.

7. The software specification consistency verification apparatus according to claim 1, wherein the specification item matching unit is configured to extract the dependence relation information using the matching rule, wherein the matching rule defines, with respect to an attribute value indicating an attribute provided to the specification item, a dependence relation establishment condition on the basis of matching of the attribute value.

8. The software specification consistency verification apparatus according to claim 3,
wherein the verification rule has set therein a number of input items indicating a number of specification items whose consistency is to be determined on the basis of the verification rule, and
wherein the dependence relation verifying unit, when detecting a mismatch between the specification items using the dependence relation information, is configured to:
extract, from the specifications, as many specification items as the number of input items set in the verification rules, and
verify a mismatch for a combination of all the specification items using the verification rule.

9. The software specification consistency verification apparatus according to claim 8,
wherein a precondition defining a condition of dependence relation between a part of the specification items, out of the specification items extracted as many as the number of input items, has been set for each of the verification rules, and
wherein the dependence relation verifying unit, upon determining that verification with regard to the precondition has been performed using another already applied verification rule when extracting, from the specifications, as many specification items as the number of input items being set in the verification rule, is configured to reuse a combination of specification items which have been determined to satisfy the precondition in the execution of the previous verification to perform verification without determining whether or not the specification item satisfies the precondition.

10. A software specification consistency verification method for verifying consistency of specification items that are data items included in software specifications having a hierarchical structure, the software specification consistency verification method comprising:
obtaining, by a computing unit comprising a memory storing data and a processor performing a computing process using the data, at least a pair of software specifications corresponding to each other;
extracting the respective specification items whose relative positions in the software specifications are preliminarily set in accordance with the hierarchical structure;
storing matching rules describing a dependence relation between the specification items included in the software specifications;
determining, using the matching rules, whether or not there exists a dependence relation between the specification items;
extracting dependence relation information identifying the specification items determined to have the dependence relation;
storing verification rules defining matching conditions between the software specifications for a particular combination of the specification items;
determining whether or not there exists a dependence relation which does not satisfy the matching condition defined in the verification rules for the identified specification items on the basis of the extracted dependence relation information;
in response to determining that there exists a dependence relation that does not satisfy the matching condition, outputting the dependence relation that does not satisfy the matching condition as mismatch information indicating a mismatch between the software specifications; and
outputting, via a predetermined user interface, the mismatch information.
